(19) United States
(12) Patent Application Publication
(10) Pub. No.: US 2024/0223668 A1
(43) Pub. Date: Jul. 4, 2024

(54) CROWDSOURCED EVENT-BASED NETWORK DATA CAPTURING METHOD AND SYSTEM

(71) Applicant: RAKUTEN MOBILE, INC., Tokyo (JP)

(72) Inventors: Tarun MISHRA, Indore (IN); Siddarth JAIN, Indore (IN); Amber JAIN, Indore (IN); Shubham RATHORE, Indore (IN)

(73) Assignee: RAKUTEN MOBILE, INC., Tokyo (JP)

(21) Appl. No.: 17/910,077

(22) PCT Filed: Jul. 8, 2022
(86) PCT No.: PCT/US2022/036510

§ 371 Date: Sep. 8, 2022

(51) Int. Cl. H04L 67/50; H04L 43/04; H04L 67/75; H04W 12/08

(52) U.S. Cl. CPC H04L 67/535; H04L 43/04; H04L 67/75; H04W 12/08

(57) ABSTRACT

A method and system of capturing data from a computing device. Here, the method can include sending a request for permission to access a location and operational state of a computing device, and upon determining that the requested access is granted, capturing data on the computing device as a background or passive process, wherein the capturing of data is based on at least one event on the computing device and aggregating the captured data. The method may further include transmitting the aggregated captured data to one or more servers. In addition, may include analyzing the transmitted data to determine one or more key performance indicators (KPIs) of a network. Further, the method may include displaying one or more layers on a graphical user interface map with respect to the determined KPIs of the network.

### BACKGROUND

### Technical Field

The present disclosure herein relates to an event-based data capturing and managing method and system that can capture, aggregate, and manage crowdsourced user data based on various network related parameters and events of end-user devices.

### Background

Data plays an important role in analyzing network performance for users of a network service provider. To analyze such network performance, a large volume of network related data is needed. In order to collect this network data, various tasks can be assigned to and performed by radio frequency (RF) engineers of a network provider. However, RF engineers can generally only collect the data of certain geographic locations and data with respect to public locations, which generally leads to a small amount of network data collected, thereby resulting in poor analysis of a network's performance. Therefore, in order to achieve ample density of the network data for proper network performance analysis and metrics, the data should be crowdsourced. Furthermore, the data should be authentic and valid user data where meaningful network performance results can be obtained.

Hence, there is a need to passively capture, aggregate, and manage crowdsourced user data based on various network related parameters and events of end-user computing devices that can be used to improve network performance of a network service provider and improve overall customer satisfaction.

### SUMMARY

According to example embodiments, an event-based data capturing and managing method and system is disclosed that can capture, aggregate, and manage crowdsourced user data based on various network related parameters and events of end-user computing devices that can be used to improve network performance of a network service provider and further improve overall customer satisfaction, among other advantages. In addition, the data capturing method and system of the disclosure described herein can operate as a plugin application (such as in the form of a Software Development Toolkit (SDK)) to any mobile device or computing device application for collecting, capturing, aggregating, and managing crowd sourced data. In particular, the data capturing method and system of the disclosure described herein can operate continuously as a passive (or background running) application or passive SDK that automatically captures event-based data from a user's computing device for network service planning, performance analysis, marketing, and improvement, among others. Here, the data capturing method and system of the disclosure described herein can be readily integrated with any third party software or application for any type of operating system (such as Android®) with support for LTE, UMTS, GSM and Wi-Fi networks, among others. Further, in some example embodiments, the data capturing method and system of the disclosure described herein can run continuously as an application or process that operates in the background of a user's device or operating system in order to collect passive network data, and further sync and upload the collected to central servers of a network every 24 hours.

In some example embodiments, passive monitoring methods can be used to capture crowd source user data based on certain events and pre-defined time intervals. This captured data can be shared with a telecommunication network operator to enhance their network's health and overall network performance, such as for analyzing key performance indicator's (KPI's) of the network. Along with RF parameters, the passing monitoring methods of the disclosure described herein can collect location parameters, device parameters, SIM information, and other desired and pre-defined or user configured details of users.

In some example embodiments, the data capturing method and system of the disclosure described herein can be anonymous or anonymously capture network and RF data from a user's device. In addition, the data capturing method and system can have the ability to integrate its passive monitoring methods with third party mobile device application providers. In addition, the data capturing method and system of the disclosure described herein can provide time-based and condition/event-based data capturing, identify indoor/outdoor samples, capture SIM slot information, capture second SIM slot data, and capture data and voice SIM recognition data. Further, the data capturing method and system of the disclosure described herein can provide a user profile that can be configured based on KPIs and geography/location of users. In addition, the data capturing method and system of the disclosure described herein can provide multi-tenancy support and capture validated or valid data with respect to dual SIM mobile devices. Also, the data capturing method and system of the disclosure described herein can present and visualize to a user the captured data within a portal or application of the disclosure described herein in layered graphical information system (GIS) maps and interactive dashboards. In addition, the data capturing method and system of the disclosure described herein can also have the ability capture various types of network and WebRTC data for monitoring network performance and call quality metrics.

In some example embodiments, the data capturing method and system of the disclosure described herein can help to predict value and risk of churn of individual customers using predictive analytics, optimize complex investments across a network using advanced resource allocation and optimization techniques, personalize strategy to target individual consumers based on multi-model data (e.g., mobile, location), discover new trends in consumer behaviour using mobile data and other relevant data, predict regional demand trends for voice/data/other traffic using forecasting techniques, and optimize field-force labour allocation using advanced resource allocation and optimization techniques.

In some example embodiments, a method of capturing data from a computing device is disclosed, the method can include sending a request for permission to access a location and operational state of a computing device; upon determining that the requested access is granted, capturing data on the computing device as a background or passive process, wherein the capturing of data is based on at least one event on the computing device; and aggregating the captured data.

In addition, the method may include transmitting the aggregated captured data to one or more servers.

Further, the method may include analyzing the transmitted data to determine one or more key performance indicators (KPIs) of a network.

Also, the method may include displaying one or more layers on a graphical user interface map with respect to the determined KPIs of the network.

In addition, the at least one event may be based on a network switching event with respect to the computing device.

Further, the at least one event may be based on a charging connection or disconnection event with respect to the computing device.

The at least one event may also be based on a display screen on event with respect to the computing device.

In addition, the at least one event may be based on at least one of airplane or flight mode event, reboot or restart event, or location-related event with respect to the computing device.

The method may also include defining a condition for the at least one event with respect to capturing data from the computing device.

Further, the condition may be based on at least one of a time period or sample count.

In other example embodiments, an apparatus for capturing data from a computing device is disclosed, including a memory storage storing computer-executable instructions; and a processor communicatively coupled to the memory storage, wherein the processor is configured to execute the computer-executable instructions and cause the apparatus to send a request for permission to access a location and operational state of a computing device; and upon determining that the requested access is granted, capture data on the computing device as a background or passive process, wherein the capturing of data is based on at least one event on the computing device; and aggregate the captured data.

In addition, the computer-executable instructions, when executed by the processor, may further cause the apparatus to transmit the aggregated captured data to one or more servers.

Further, the computer-executable instructions, when executed by the processor, may further cause the apparatus to analyze the transmitted data to determine one or more key performance indicators (KPIs) of a network.

Also, the computer-executable instructions, when executed by the processor, may further cause the apparatus to display one or more layers on a graphical user interface map with respect to the determined KPIs of the network.

The at least one event may further be based on a network switching event with respect to the computing device.

In addition, the at least one event may be based on a charging connection or disconnection event with respect to the computing device.

Also, the at least one event may be based on a display screen on event with respect to the computing device.

Further, the at least one event may be based on at least one of airplane or flight mode event, reboot or restart event, or location-related event with respect to the computing device.

In addition, the computer-executable instructions, when executed by the processor, may further cause the apparatus to define a condition for the at least one event with respect to capturing data from the computing device.

In other example embodiments, a non-transitory computer-readable medium comprising computer-executable instructions for capturing data from a computing device by an apparatus is disclosed, wherein the computer-executable instructions, when executed by at least one processor of the apparatus, cause the apparatus to send a request for permission to access a location and operational state of a computing device; upon determining that the requested access is granted, capture data on the computing device as a background or passive process, wherein the capturing of data is based on at least one event on the computing device; and aggregate the captured data.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a diagram of a general system architecture of the data capturing method and system of the disclosure described herein according to one or more embodiments;

FIG. 2 illustrates another diagram of components and modules of the data capturing method and system of the disclosure described herein according to one or more embodiments;

FIG. 3 illustrates a flowchart of the data capturing method and system of the disclosure described herein according to one or more embodiments;

FIGS. 4A-4B illustrate tables of API information for the data capturing method and system of the disclosure described herein according to one or more embodiments;

FIG. 5A illustrates a table of various events for the data capturing method and system of the disclosure described herein according to one or more embodiments;

FIGS. 5B-13 illustrate tables of various parameters for the data capturing method and system of the disclosure described herein according to one or more embodiments;

FIG. 14A illustrates a first half of a graphical user interface portal of a dashboard for the data capturing method and system of the disclosure described herein according to one or more embodiments;

FIG. 14B illustrates a second half of the graphical user interface portal of the dashboard of FIG. 14A for the data capturing method and system of the disclosure described herein according to one or more embodiments; and

FIGS. 15A-15B illustrate graphical user interface portals of various maps for the data capturing method and system of the disclosure described herein according to one or more embodiments;

### DETAILED DESCRIPTION

The following detailed description of example embodiments refers to the accompanying drawings. The same reference numbers in different drawings may identify the same or similar elements.

The foregoing disclosure provides illustrations and descriptions, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

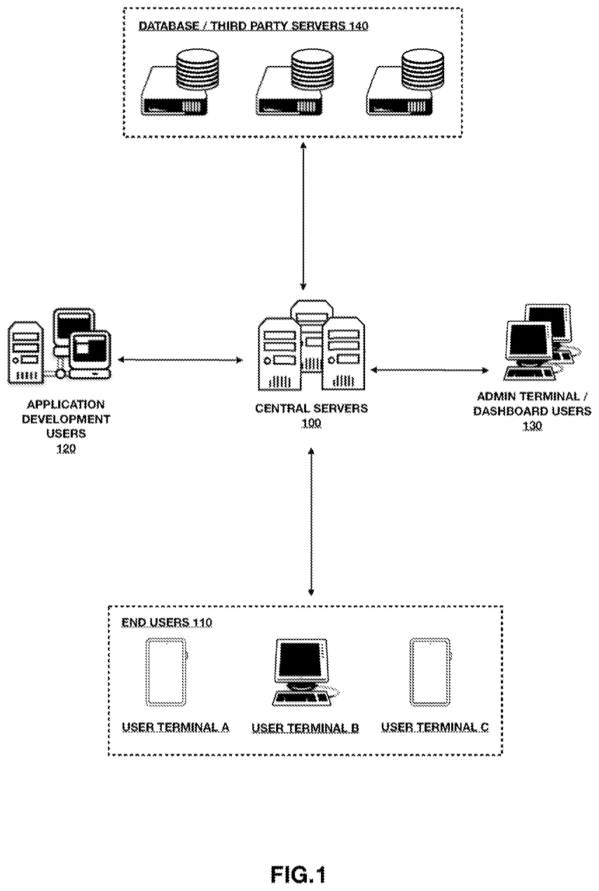

FIG. 1 illustrates a diagram of a general network architecture according to one or more embodiments. Referring to FIG. 1, end users 110, application development users 120, and admin terminal/dashboard users 130 (collectively referred to herein as users 110, 120, and 130) can be in bi-directional communication over a secure network with central servers or application servers 100 according to one or more embodiments. In addition, users 110, 120, 130 may also be in direct bi-directional communication with each other via the network system of the disclosure described herein according to one or more embodiments. Here, users 110 can be any type of customer of a network or telecommunication service provider, such as users operating computing devices and user terminals A, B, and C. Each of users 110 can communicate with servers 100 via their respective terminals or portals. Users 120 can include application development members or support agents of the network service provider for developing and/or integrating the data capturing method and system of the disclosure described herein, including assisting and providing support services to end users 110. Admin terminal/dashboard users 130 may be any type of user with access privileges for accessing a dashboard or management portal of the disclosure described herein, wherein the dashboard portal can provide various user tools, maps, and customer support options. It is contemplated within the scope of the present disclosure described herein that any of users 110 and 120 may also access the admin terminal/dashboard 130 of the disclosure described herein.

Still referring to FIG. 1, central servers 100 of the disclosure described herein according to one or more embodiments can be in further bi-directional communication with database/third party servers 140, which may also include users. Here, servers 140 can include vendors and databases where various captured, collected, or aggregated data may be uploaded thereto or stored thereon and retrieved therefrom for network analysis and measurements by servers 100. However, it is contemplated within the scope of the present disclosure described herein that the data capturing method and system of the disclosure described herein can include any type of general network architecture.

Still referring to FIG. 1, one or more of servers or terminals of elements 100-140 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-140 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-140. For example, the bus may be a communication bus, a cross-over bar, a network, or the like. The bus may be implemented using single or multiple (two or more) connections between the set of components of one or more of servers or terminals of elements 100-140. The disclosure is not limited in this regard.

One or more of servers or terminals of elements 100-140 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-140 and/or of the set of components of one or more of servers or terminals of elements 100-140 (e.g., memory, storage component, input component, output component, communication interface, rendering component).

One or more of servers or terminals of elements 100-140 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-140 may store information and/or computer-readable instructions and/or code related to the operation and use of one or more of servers or terminals of elements 100-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-140 may further comprise an input component. The input component may include one or more components that permit one or more of servers and terminals 100-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-140 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-140 may further comprise a communication interface. The communication interface may include a receiver component, a transmitter component, and/or a transceiver component. The communication interface may enable one or more of servers or terminals of elements 100-140 to establish connections and/or transfer communications with other devices (e.g., a server, another device). The communications may be enabled via a wired connection, a wireless connection, or a combination of wired and wireless connections. The communication interface may permit one or more of servers or terminals of elements 100-140 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like.

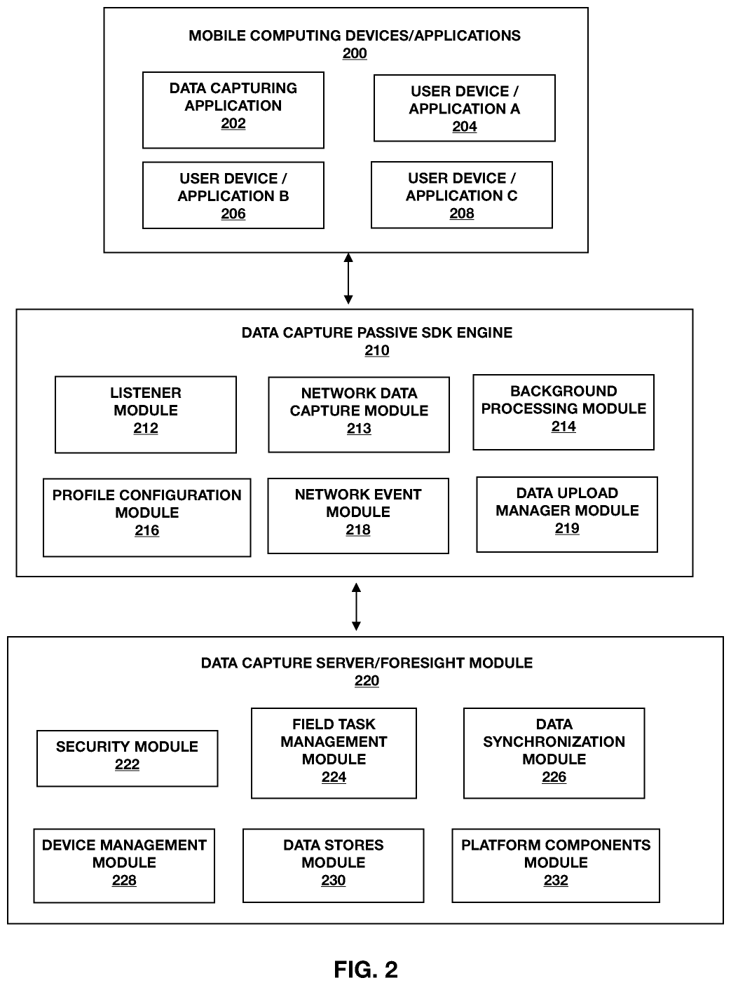

FIG. 2 illustrates various modules and components architecture of the data capturing method and system of the disclosure described herein. Here, the data capturing method and system can include a data capture passive SDK engine 210 in bi-directional communication with mobile devices/applications 200 and data capture server/foresight module 220. In particular, in example embodiments, including any end-user or customer mobile device having user device/application A 204, user device/application B 206, and user device/application C 208, wherein each user device/application includes an operating system (OS) software for hosting data capturing application 202 of the disclosure described herein. Here each mobile device/application 204-208 can include data capturing application 202 integrated therewith, including the data capturing method and system of the disclosure described herein, stored thereon and executing/operating in the background (or passively) of the user devices as a process or in combination with user devices/applications 204-208. Here, data capture passive SDK engine 210 of the disclosure described herein can include a listener module 212 for listening and detecting user events on their mobile device (including time interval or events within a defined time period). In addition, engine 210 can also include network data capture module 213 for capturing various network data related events associated with the user's device, OS, and applications, and background processing module 214 for allowing the data capturing method and system to operate passively or in the background of a user device's OS.

Still referring to FIG. 2, module 210 may also include a data upload manager module 219 for uploading the captured and aggregated data from the users to one or more databases or servers for storage and analysis, among others. Module 210 may further include profile configuration module 216 that can allow any user of the data capturing application, method, and system of the disclosure described herein to customize and configure various personalized settings, such as background operation and the types of data to be collected from the user's device, in addition to configuring profiles based on KPIs and geography/location of users. Further, module 210 may also include a network event module 218 for capturing and collecting various network related events associated with the user's device, OS, or applications.

Still referring to FIG. 2, data capture server/foresight module 220 can include a security module 222 for ensuring that captured data is securely stored and/or uploaded to databases, in addition to requesting and providing permissions for operation of the data capturing application 202 with respect to the user device's OS and applications. Further, module 220 can also include field task management module 224 for managing the captured data, including executing various types of analysis on the captured data. Module 220 can also include data synchronization module 226 for synchronizing and uploading the captured data from the user's device with one or more databases or servers. Module 220 can further include a device management module 228 for managing the various types of user devices, applications, and OS software. Further, data stores module 230 can store the collected and captured data locally on the user's device or within the data capturing application 202 of the disclosure described herein for transfer or upload to one or more databases at pre-defined time or based on certain user settings (such as being connected to Wi-Fi). In addition, module 220 may also include a platform components module 232 for providing various information on platforms used with respect to the data capturing application 202 of the disclosure described herein.

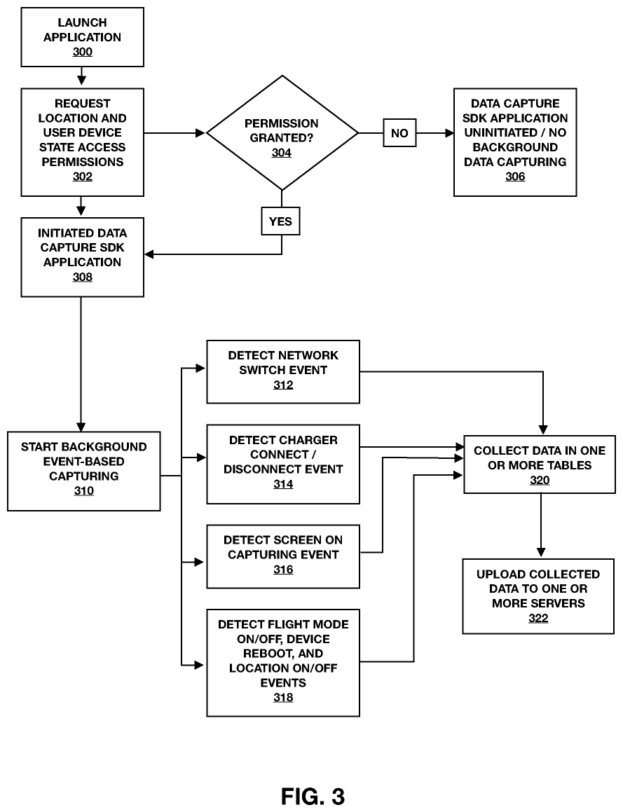

FIG. 3 illustrates a process flow for the data capturing application 202 and data capturing method and system of the disclosure described herein, according to an example embodiment. Here, the process can begin at step 300 where the data capturing application residing on a user's device receives a request to be launched by the user. Next, at step 302, the data capturing method and system of the data capturing application can request location and user device operational state access/events/parameters permissions 302 from the user or from the user device OS (such as an Android® based device). At step 304, the process can determine if permission was granted for the data capturing application to access and capture location and phone state/events/parameters of the user's device. In example embodiments, such permissions can be for allowing data capturing while the application is in use (or active), allowing data capturing only once, allowing data capturing at all times, or denying data capturing, among others, depending on the user device's OS (and version). If permission is denied, then the process moves to step 306, wherein the data capturing method and system of the data capturing application of the disclosure described herein is uninitiated and no background data capturing occurs. If permission is granted, then the process moves to step 308, wherein the data capturing method and system of the data capturing application of the disclosure described herein is initiated and begins its data capturing operation in the background.

Still referring to FIG. 3, at step 310, the data capturing method and system of the disclosure described herein begins to capture various events, conditions, states, parameters, and properties of the user's device, OS, and application in the background or as a passive process. Specifically, such events can include, among others, detecting network switching events 312 (such as switching from an in-network service to out-of-network, to another service provider, or to network roaming, among others), detecting charger connection/disconnection events 314 with respect to the user's device. In addition, such events can also include detecting screen on capturing events 316 (such as when user checks his/her phone for notifications, application execution, internet browsing, etc.) which can also be based on detecting within a defined timed interval or time period (such as every 15 minutes). Further, such events can also include detecting flight or airplane mode on/off events, user device reboot or restart events, and user location-related and location access on/off events, among others. Next, at step 320, any one or more of events 312-318 are sent to one or more servers or databases to be collected, aggregated, parsed, structured, and/or organized within one or more tables. Next, at step 322, the collected, captured, aggregated, parsed, structured, and/or organized data is then transmitted and uploaded to one or more servers 322 to be analyzed with respect to network performance, among others. Here, such transmission and uploading of data can be based on user settings, such as at a certain time or when certain conditions are met, such as when the user's device is on a Wi-Fi network, battery level at a certain level, and connected to an external power source, among others.

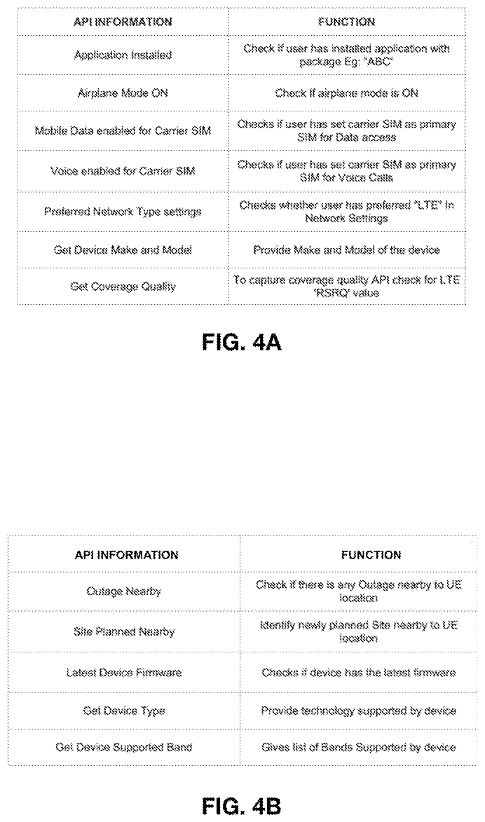

FIGS. 4A-4B illustrates various types of Application Programming Interface (API) information is exposed by the data capturing application or shared with other third-party applications that can help in analyzing network performance. In particular, the passively or background collected data via the data capturing application of the disclosure described herein can be fetched and analyzed by other third-party applications and processes (such as locally installed applications on the user's device or remotely) using the listed APIs of FIGS. 4A-4B at any time for various types of operations, analysis, and user/OS permitted uses.

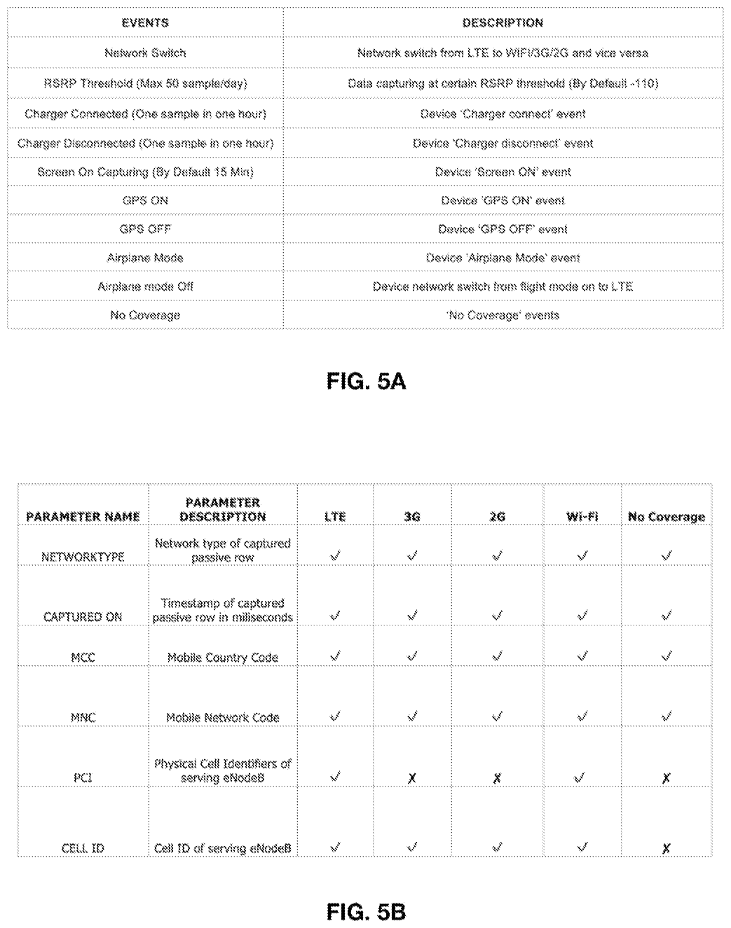

FIG. 5 illustrates various types of events that can trigger collection or capturing of data from the user's device, OS, and applications by the data capturing method and system of the data capturing application of the disclosure described herein, according to an example embodiment. Here, a user can pre-define a specific time interval or time period for which an event or sample data is captured. As an example, the data capturing application of the disclosure described herein can be configured to collect “screen on” events for every 15-minute interval. In addition, the user can pre-define the number of sample data to be collected per each event per a specified time period. For example, up to a maximum of 50 samples per each 24-hour period that can be captured with respect to RSRP threshold events, among other events. Here, the volume of collected data can be easily managed by defining the amount of data captured (including the time interval).

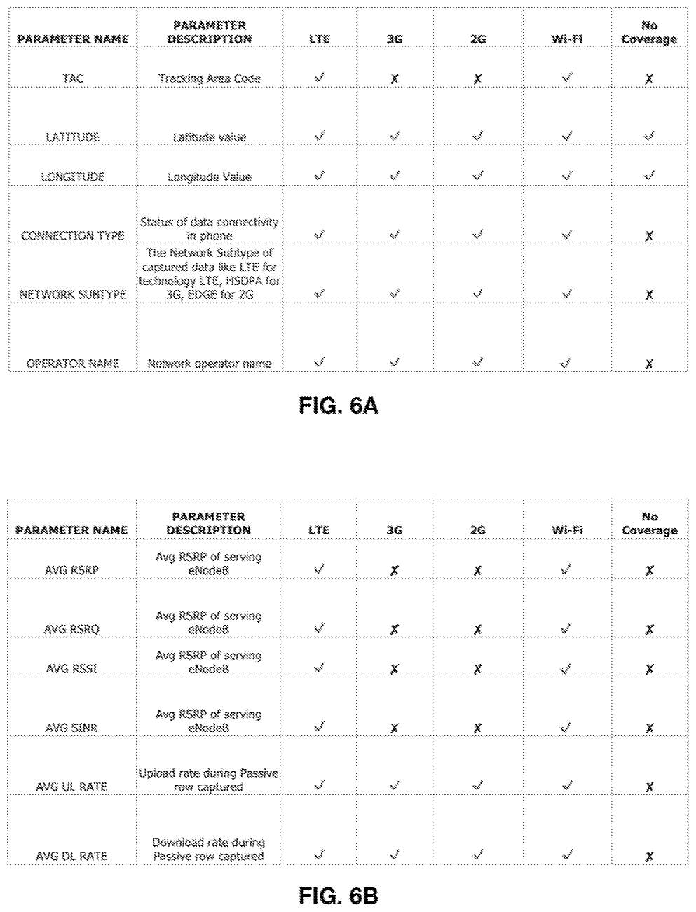

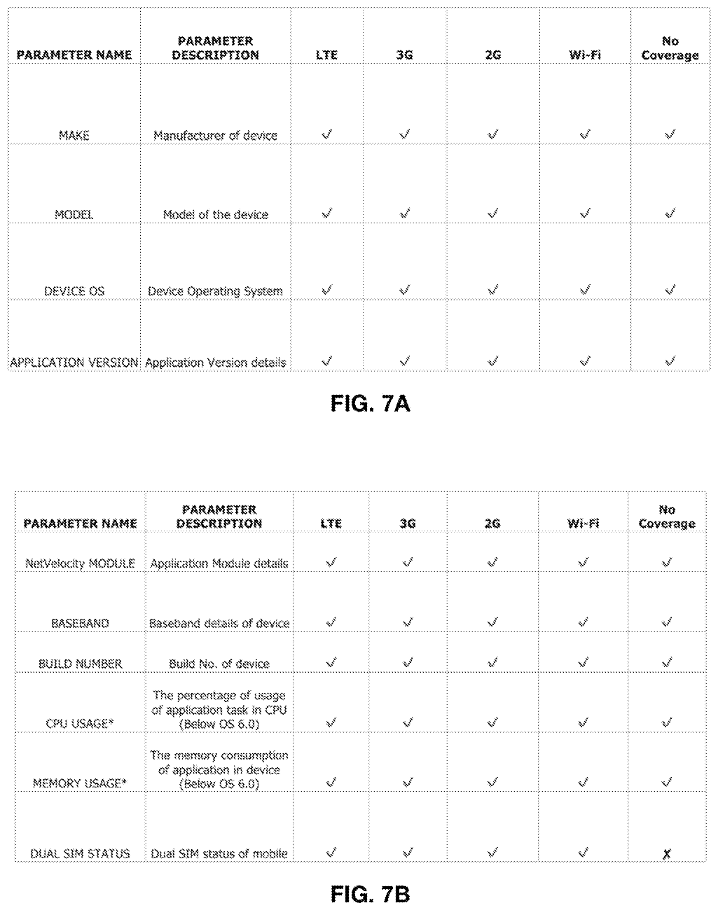

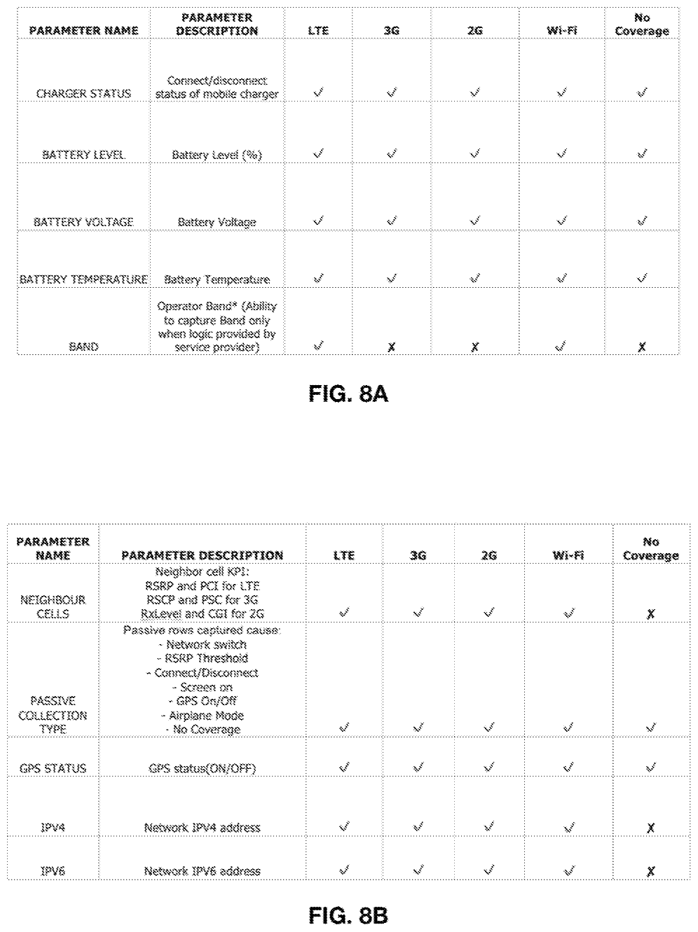

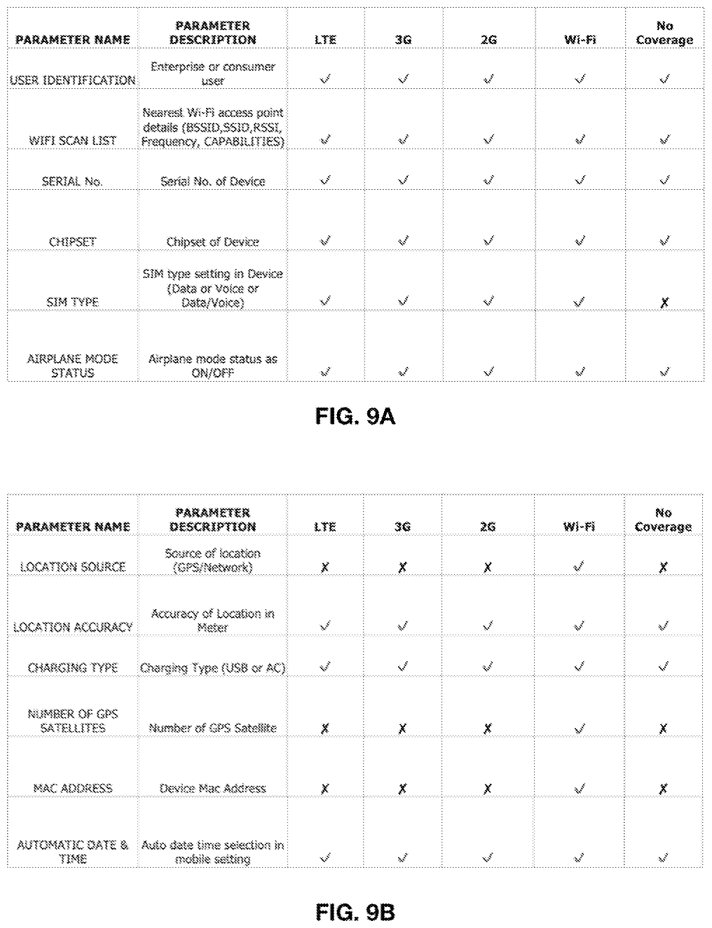

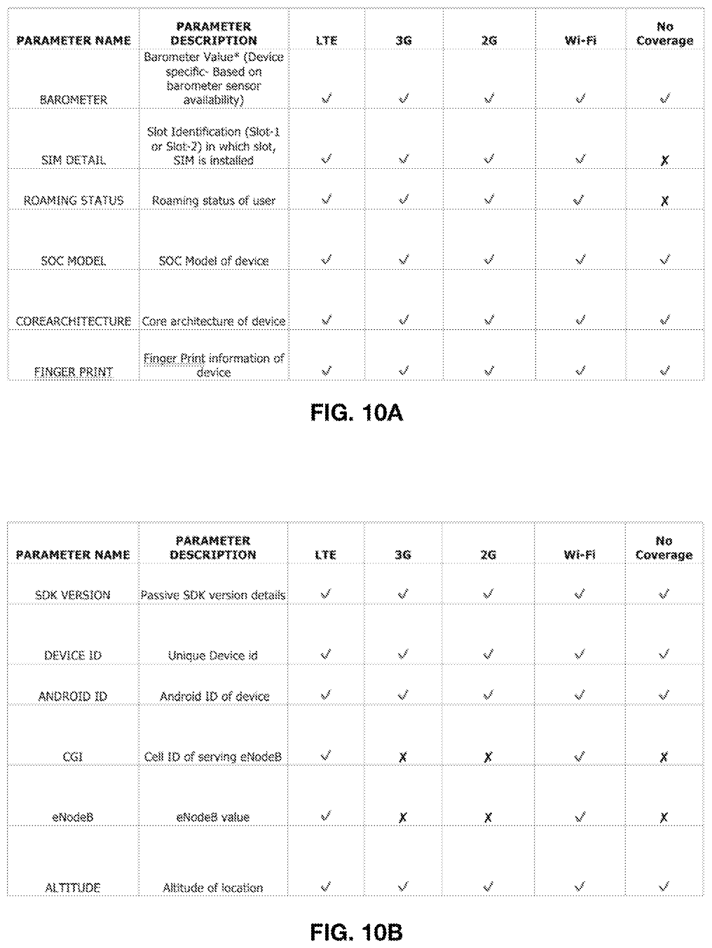

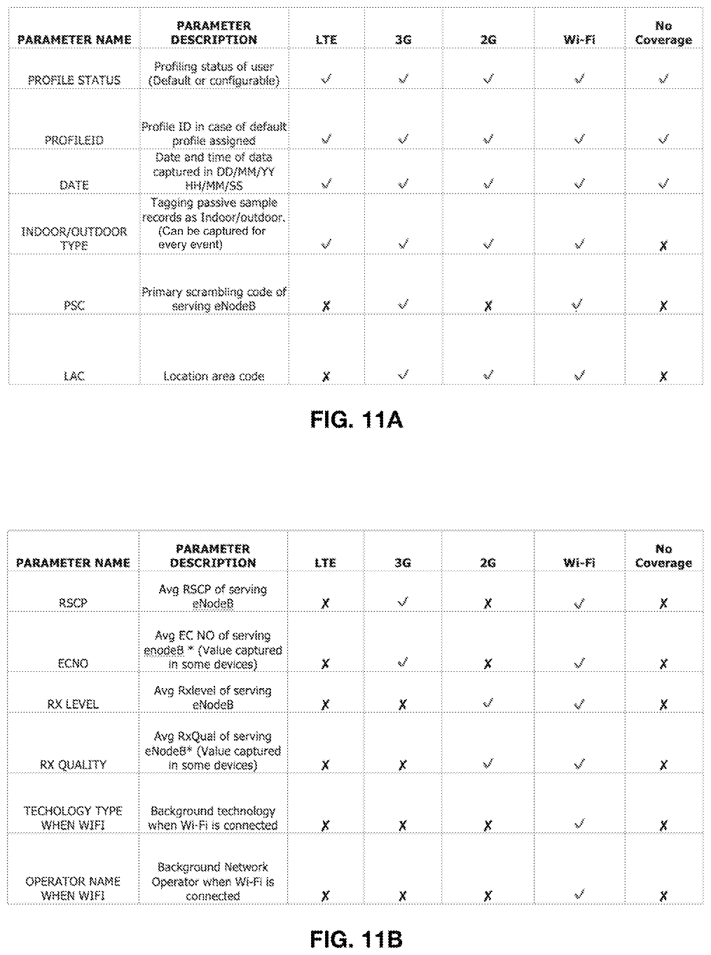

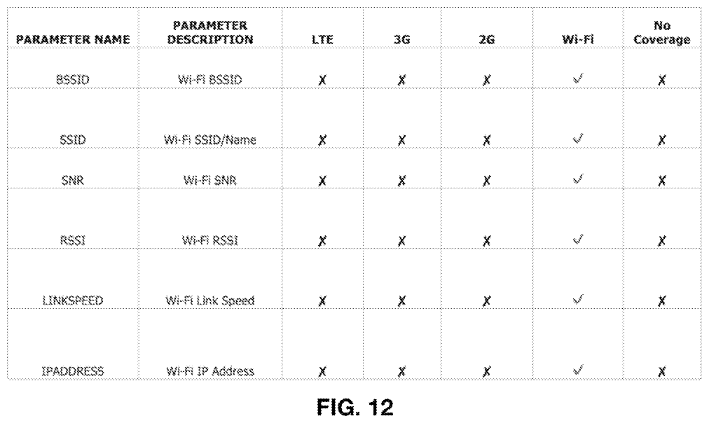

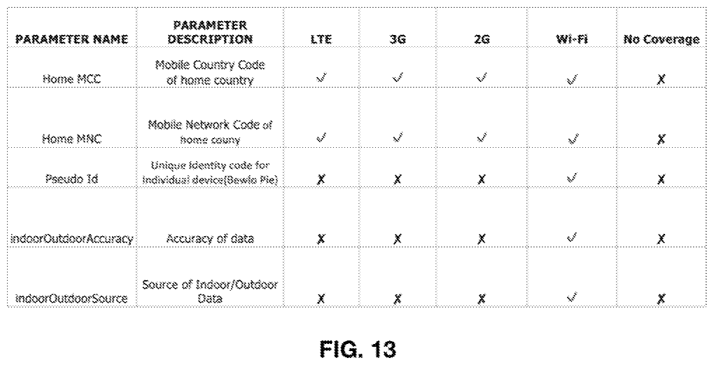

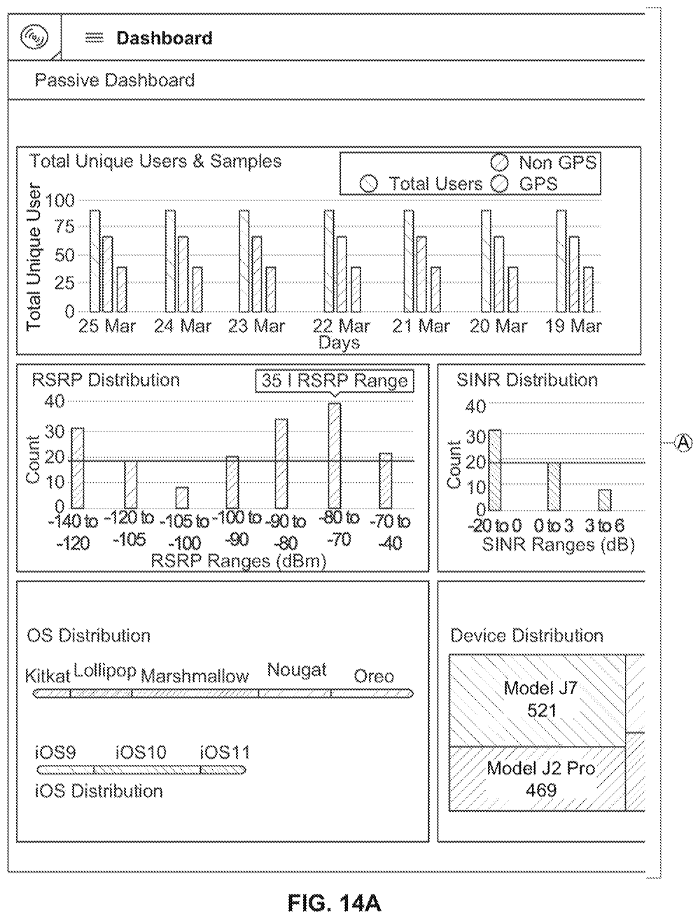

FIGS. 5B-13 illustrates various types of parameters that can be captured from a user's device, application, and OS with respect to analyzing various KPI's of a user's device, application, and OS, depending on the type of network connection of the user (such as LTE, 3G, 2G, Wi-Fi, or no coverage). Here, the captured data with respect to any one or more parameters within FIGS. 5B-13 can be used by the data capturing method and system of the disclosure described herein to provide network performance and KPI analysis to a user. Here, the foregoing parameters with respected FIGS. 5B-13 pertain to the Android® based OS user devices, but it is contemplated within the scope of the disclosure described herein that any other same or similar parameters may be used with any other OS of a user device.

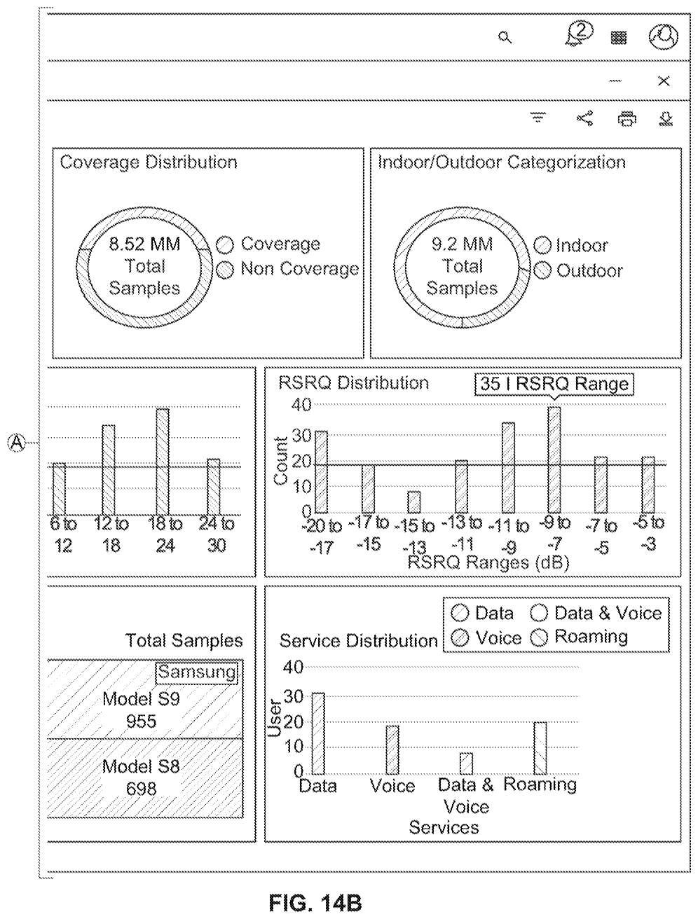

FIGS. 14A-14B illustrates a graphical user interface (GUI) dashboard and reporting portal that can provide to a user readily available summarized analytical view of network conditions and generate reports for the captured data. In particular, as shown in FIGS. 14A-14B (wherein FIG. 14B is a continuation of FIG. 14A), such reporting can include total unique users and samples, coverage distribution, indoor/outdoor categorization, RSRP distribution, SINR distribution, RSRQ distribution, OS distribution, device distribution, and service distribution with respect to users of the service provider's network or any other service provider/operator.

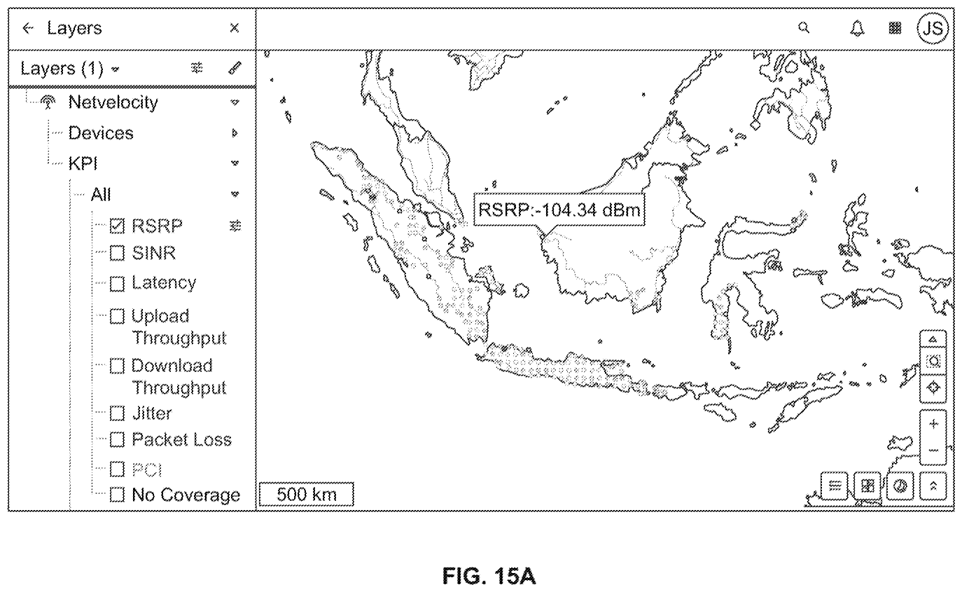

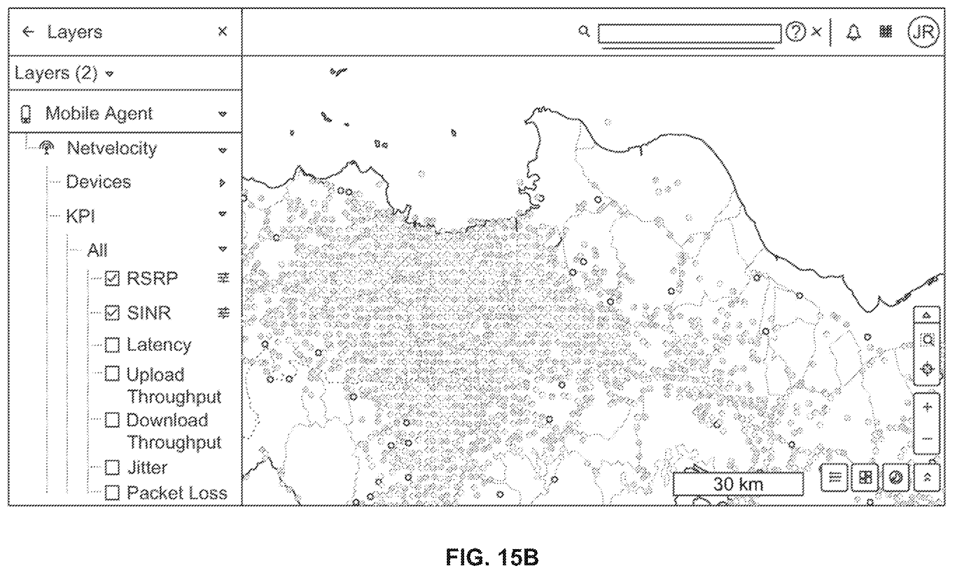

FIGS. 15A-15B illustrate graphical user interfaces with respect to GIS maps of the data capturing method and system within the dashboard and reporting portal of the disclosure described herein. Here, the dashboard portal can generate various visual KPI-related network layers based on signal strength, quality, upload/download throughput, RSRP, SINR, and jitter, among others, from the captured user data. Here, each layer may be color coded or include any type of indicia to separate or differentiate it from another layer on the map. In addition, the dashboard and reporting portal can provide a visual representation of identified cells which are swapped or misaligned by using data measured by the passive data collection agents and processes of the data capturing application of the disclosure described herein. In addition, the dashboard and reporting portal can generate various analytics and metrics which can help network carriers to identify geographic areas which have coverage patches as well as growth for other geographic areas. In addition, the dashboard and reporting portal can also provide functionality and graphical visualizations for carriers to identify areas where planned coverage is acceptable or good, whereas measured coverage is inferior via “smart coverage layer” on the GIS map within the dashboard and reporting portal.

It is contemplated within the scope of the present disclosure described herein that the data capturing method and system of the data capturing application can help network service providers to improve routing and quality of service by analyzing network traffic in near real-time. Other advantages of the disclosure described herein include analyzing call data records in near real-time to identify aberrant or inconsistent behavior, allowing network engineers to analyze crowdsourced data to identify an outage, tailoring marketing campaigns to individual customers using captured location-based data, and utilizing insights into customer behavior and data usage to develop new network service plans, among other advantages. Additional advantages and improvements can include predicting lifetime value and risk of churn for individual customers using predictive analysis based on the captured data, optimizing complex hardware and software investments across a network using advanced resource allocation and optimization methods based on the captured data, personalizing strategies to target individual network customers based on multi-modal data (e.g., mobile, location), identifying new trends in consumer behavior using the captured data, predicting regional demands and trends with respect to voice/data and other network traffic using forecasting techniques based on the captured data, and optimizing field-force labor allocation using advanced resource allocation and optimization methods based on the captured data, among other advantages.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of capturing data from a computing device, the method comprising:
sending a request for permission to access a location and operational state of a computing device;
upon determining that the requested access is granted, capturing data on the computing device as a background or passive process, wherein the capturing of data is based on at least one event on the computing device; and
aggregating the captured data.

2. The method of claim 1, further comprising:
transmitting the aggregated captured data to one or more servers.

3. The method of claim 2, further comprising:
analyzing the transmitted data to determine one or more key performance indicators (KPIs) of a network.

4. The method of claim 3, further comprising:
displaying one or more layers on a graphical user interface map with respect to the determined KPIs of the network.

5. The method of claim 1, wherein the at least one event is based on a network switching event with respect to the computing device.

6. The method of claim 1, wherein the at least one event is based on a charging connection or disconnection event with respect to the computing device.

7. The method of claim 1, wherein the at least one event is based on a display screen on event with respect to the computing device.

8. The method of claim 1, wherein the at least one event is based on at least one of airplane or flight mode event, reboot or restart event, or location-related event with respect to the computing device.

9. The method of claim 1, further comprising:
defining a condition for the at least one event with respect to capturing data from the computing device.

10. The method of claim 9, wherein the condition is based on at least one of a time period or sample count.

11. An apparatus for capturing data from a computing device, comprising:
a memory storage storing computer-executable instructions; and
a processor communicatively coupled to the memory storage, wherein the processor is configured to execute the computer-executable instructions and cause the apparatus to:
send a request for permission to access a location and operational state of a computing device;
upon determining that the requested access is granted, capture data on the computing device as a background or passive process, wherein the capturing of data is based on at least one event on the computing device; and
aggregate the captured data.

12. The apparatus of claim 11, wherein the computer-executable instructions, when executed by the processor, further cause the apparatus to:
transmit the aggregated captured data to one or more servers.

13. The apparatus of claim 12, wherein the computer-executable instructions, when executed by the processor, further cause the apparatus to:
analyze the transmitted data to determine one or more key performance indicators (KPIs) of a network.

14. The apparatus of claim 13, wherein the computer-executable instructions, when executed by the processor, further cause the apparatus to:
display one or more layers on a graphical user interface map with respect to the determined KPIs of the network.

15. The apparatus of claim 11, wherein the at least one event is based on a network switching event with respect to the computing device.

16. The apparatus of claim 11, wherein the at least one event is based on a charging connection or disconnection event with respect to the computing device.

17. The apparatus of claim 11, wherein the at least one event is based on a display screen on event with respect to the computing device.

18. The apparatus of claim 11, wherein the at least one event is based on at least one of airplane or flight mode event, reboot or restart event, or location-related event with respect to the computing device.

19. The apparatus of claim 11, wherein the computer-executable instructions, when executed by the processor, further cause the apparatus to:
define a condition for the at least one event with respect to capturing data from the computing device.

20. A non-transitory computer-readable medium comprising computer-executable instructions for capturing data from a computing device by an apparatus, wherein the computer-executable instructions, when executed by at least one processor of the apparatus, cause the apparatus to:
send a request for permission to access a location and operational state of a computing device;
upon determining that the requested access is granted, capture data on the computing device as a background or passive process, wherein the capturing of data is based on at least one event on the computing device; and
aggregate the captured data.
